(19) United States
(12) Patent Application Publication
(10) Pub. No.: US 2026/0026440 A1
(43) Pub. Date: Jan. 29, 2026

(54) BALE HANDLING APPARATUS AND METHOD

(71) Applicant: Hustler Equipment Limited, Hastings (NZ)

(72) Inventor: Aaron Weir, Wellington (NZ)

(73) Assignee: Hustler Equipment Limited, Hastings (NZ)

(21) Appl. No.: 19/280,168

(22) Filed: Jul. 25, 2025

(30) Foreign Application Priority Data
Jul. 26, 2024 (NZ) 813289

(51) Int. Cl. A01D 87/12; A01F 29/00

(52) U.S. Cl. CPC A01D 87/127; A01F 29/005; A01D 2087/128

(57) ABSTRACT

A bale handling apparatus is disclosed, comprising a plurality of jaws configured to receive a bale, one or more tines configured to pierce the bale upon reception within the jaws, and one or more blades configured to cut binding material of the bale when received. A distinctive feature of the apparatus is its configuration to clamp the bale at a position rearward of the location where the one or more blades are configured to cut the binding material. Additionally, a method of operating a bale handling apparatus is disclosed, comprising holding a square bale within the apparatus, cutting its binding strings, and subsequently dropping a first portion of the bale while retaining a second portion of the bale and the cut strings on said second portion. This invention provides improved control over bale processing and binding material management.

### FIELD OF THE INVENTION

This invention relates to a bale handling apparatus. The invention also relates to a method of operating a bale handling apparatus.

### BACKGROUND OF THE INVENTION

Bales of material are used in various settings, including in agriculture. For example, bales of silage, hay, straw or the like can be used as feed or bedding material for animals. Bales are typically large and require machinery to transport them or load them into other apparatuses like wagons or freestanding bale feeders. Bales come in different sizes and shapes, include round bales and square bales. Bales are typically held together by binding material such as plastic wrap, strings, or netting. Various pieces of machinery are available to handle bales of various types. This machinery may be incorporated into a vehicle or configured as an attachment to a vehicle, for example at the end of a loader arm.

### SUMMARY OF THE INVENTION

According to one example embodiment there is provided a bale handling apparatus comprising:
a plurality of jaws configured to receive a bale;
one or more tines configured to pierce the bale when the bale is received in the jaws; and
one or more blades configured to cut binding material of the bale when the bale is received in the jaws;
wherein the bale handling apparatus is configured to clamp the bale at a position rearward of a position at which the one or more blades are configured to cut the binding material.

Embodiments of the bale handling apparatus may be implemented according to any one of the dependent claims 2 to 16.

According to another example embodiment there is provided a method of operating a bale handling apparatus comprising:
holding a square bale in the bale handling apparatus;
cutting binding strings of the bale with the bale handling apparatus;
dropping a first portion of the bale from the bale handling apparatus while retaining a second portion of the bale in the bale handling apparatus and retaining the cut strings on the second portion of the bale.

Embodiments of the method may be implemented according to any one of the dependent claims 18 to 20.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings, which are incorporated in and constitute part of the specification, illustrate embodiments of the invention and together with the general description of the invention given above and the detailed description of embodiments given below serve to explain the principles of the invention.

FIG. 1 is a perspective view of a bale handling apparatus according to one example.

FIG. 2 is a set of views of the bale handling apparatus of FIG. 1 and a bale in a first configuration, wherein, FIG. 2A is a first view thereof; FIG. 2B is a second view thereof; and FIG. 2C is a third view thereof.

FIG. 3 is a set of views of the bale handling apparatus and bale of FIG. 2 in a second configuration, wherein, FIG. 3A is a first view thereof; FIG. 3B is a second view thereof; and FIG. 3C is a third view thereof.

FIG. 4 is a set of views of the bale handling apparatus of FIG. 1 and another bale in a first configuration, wherein, FIG. 4A is a first view thereof; FIG. 4B is a second view thereof; and FIG. 4C is a third view thereof.

FIG. 5 is a set of views of the bale handling apparatus and bale of FIG. 4 in a second configuration, wherein, FIG. 5A is a first view thereof; FIG. 5B is a second view thereof; and FIG. 5C is a third view thereof.

FIG. 6 illustrates steps of a method of using a bale handling apparatus, wherein, FIG. 6A is a first view thereof; FIG. 6B is a second view thereof; and FIG. 6C is a third view thereof.

### DETAILED DESCRIPTION OF THE INVENTION

The bale handling apparatus described herein may enable the handling of a range of different bale types, including round bales and square bales. The bales can be composed of baled material, for example silage, hay or the like bound by binding material such as strings, wrap or netting. The bale handling apparatus may enable binding material of these different types of bales to be cut—for example wrap or netting of round bales or strings of square bales may be cut using the apparatus. The bale handling apparatus may enable bales of different types to be portioned—for example by splitting round bales or breaking apart square bales. The bale handling apparatus may improve the loading of bales into bale holders such as feed out wagons or freestanding bale feeders. The bale handling apparatus may enable cut binding material of bales to be retained when at least a portion of the bale is deposited from the apparatus. The apparatus may also be able to handle loose feed by way of the bucket attachment. The ability to perform all of these functions, which may otherwise require several different apparatuses, may save a user the cost of having to buy several different apparatuses to handle different types of material. For example, grabbing and loading of bales may otherwise require a specialised bale grab, splitting bales may otherwise require a specialised bale slicer and handling of loose feed may otherwise require a bucket loader attachment of the like. This may also save the user the hassle and time taken to switch between different apparatuses for different jobs.

The bale handling apparatus may be particularly advantageous when handling square bales. The bale feeding apparatus may allow square bales to be more firmly retained during handling. The bale feeding apparatus may allow the binding material of square bales to be retained after cutting. This may allow the cut binding material to be safely and conveniently separated from the deposited baled material. The binding material may be retained on a portion of the bale that is not dropped from the apparatus when another portion is broken off and dropped from the apparatus, preventing the binding material from ending up with the dropped portion of the bale, for example in a feed out wagon or freestanding bale feeder. The retained binding material may be placed where it can be easily collected from (for example over the side of a wagon or bale feeder) when dropping the other portion of the bale. In some examples, the apparatus may retain the binding material on the apparatus after depositing the bale. This may allow the binding material to be subsequently transported to and deposited at a suitable location for collection or disposal.

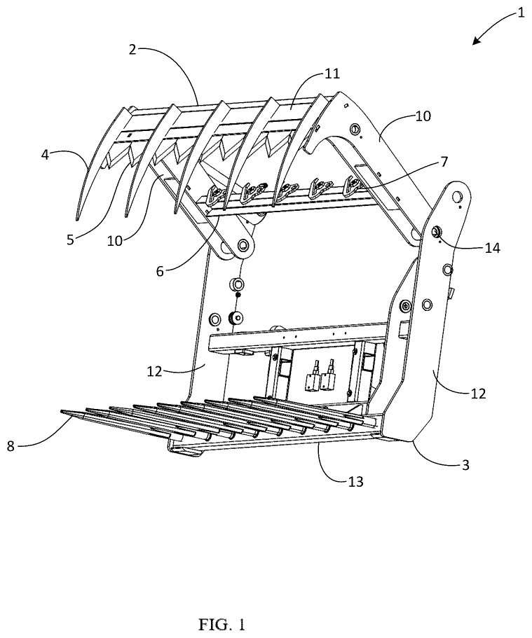

FIG. 1 illustrates a bale handling apparatus 1 according to an example embodiment.

The bale handling apparatus 1 has jaws 2, 3 for receiving a bale. In the example of FIG. 1, the bale handling apparatus has two jaws. In other examples, there may be more than two jaws. The jaws can include upper and lower jaws. In the example of FIG. 1, the jaw 2 is an upper jaw and the jaw 3 is a lower jaw. In examples with more than two jaws, there could for example be two or more upper jaws. The upper jaws could be side by side or “nested” one within the other(s).

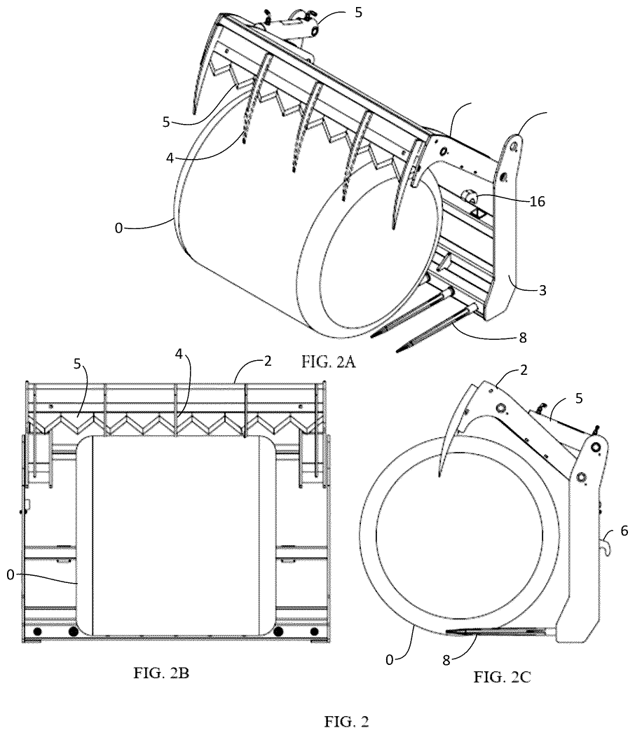

Two of the jaws can be movable towards and away from each other to move between open and closed configurations, as well as configurations in between fully opened and fully closed. The jaws may pivot relative to each other, translate linearly relative to each other, or move by a combination of translation and rotation. One or more of the jaws may be movable relative to the rest of the bale handling apparatus to effect the relative movement. Zero, one or more of the jaws may be stationary, with movement one or more other jaws effecting the relative movement. In the example of FIG. 1, the jaws 2 and 3 are configured to pivot relative to each other. The jaw 3 in this example can remain fixed while the jaw 2 pivots about pivot point 14 to cause the jaws 2, 3 to open and close. The moving jaw(s) can be moved by any suitable means. In some examples, the moving jaw(s) can be moved by a hydraulic actuator, such as the hydraulic cylinder 15 shown in FIG. 2.

The jaws 2, 3 in the example of FIG. 1 include arms and cross members connected between the arms. Specifically, the jaw 2 includes arms 10 and cross member 11. The jaw 3 includes arms 12 and cross member 13.

The bale handling apparatus 1 also includes tines 4. The tines 4 are provided to pierce the bale when the bale is received in the jaws 2, 3. The tines 4 help to hold the bale in the jaws 2, 3 when they are engaged with the bale. The tines 4 that pierce the bale may be provided on one of the jaws 2, 3. In the example of FIG. 1, the upper jaw 2 has tines 4 for piercing the bale. Specifically, the tines 4 are mounted to the cross member 11. In other examples, the tines 4 could be placed on a different member (e.g. a different cross member of an arm) of the jaw 2 or on a different jaw altogether.

Tines may also be used as at least part of a bale support to support the base of the bale. In the example of FIG. 1, the lower jaw 3 has tines 8 to support the bale. The tines 8 may go under the bale or at least partly pierce the base of the bale to support it against gravity. In other examples, other forms of bale support, such as a platform, scoop or bucket, may be used.

The apparatus may also be provided with a separate bucket that can be selectively attached to and detached from the lower jaw 3. The bucket may be placed over the lower tines 8 and attached to the arms 12 of the lower jaw 3.

The bale handling apparatus 1 has one or more blades 5 for cutting binding material of the bale. The blades 5 may be rearward of the tines 4. By rearward, it is meant that the blades are further from the front of the apparatus which initially receives bales, i.e. the end at which the tines 4 are shown in the non-limiting example of FIG. 1. The blades may be arranged such that they can cut through the binding material of one or more known types of bale sufficiently well to allow the baled material to be at least partially removed from the binding material. For example, the blades 5 can be arranged to cut substantially the whole way across wrap or netting of a round bale and/or to cut in the locations of strings of a square bale. In the case of more than one blade, the blades may be placed with little to substantially no space between them in the lateral direction (i.e. the direction from one arm 10 to the other) to reduce the chance of binding material between the blades remaining uncut. In the example of FIG. 1, several blades are placed side-by-side across most of the width of the jaw 2. Specifically, the blades 5 are mounted to the cross member 11. In this example, the blades 5 and piercing tines 4 are on the same cross member 11. In other examples, they may be provided on different cross members of the same jaw or on different jaws altogether. For example, the upper jaw 2 could have two cross members near each other towards the front of the jaw 2, one cross member having tines 4 and the other cross member having the blades 5.

The bale handling apparatus 1 can be configured to clamp the bale at a position rearward of the blades 5. The apparatus 1 can clamp the bale using any one or combination of clamping devices. For example, one or more of the jaws may clamp onto the bale. In some examples, one or more clamping members such as bars and/or plates may be arranged to clamp onto the bale. The clamping members may be on one or more of the jaws. In the example of FIG. 1, the bale handling apparatus 1 has a bar 6 for clamping onto a bale. The bar 6 has an inverted, square U profile, but other shapes of bar could be used. In other examples, more than one bar could be used to clamp on to the bale. In other examples, one or more plates could be used to clamp onto the bale, for example a row of plates could be provided across the upper jaw 2 with their edges directed downwards onto the bale.

The clamping device(s) are located rearwardly of the blade(s). By rearwardly, it is meant that the clamping device(s) are located further from the end of the jaw that a bale is first received at than the blades. Another way to put this is that the bale reaches the blade(s) before it reaches the clamping device(s) when it is being received in the jaws. This means that the clamping device(s) clamp onto the bale at a location that is rearward, i.e. further into the jaws, of the location at which the blade(s) cut. As shown in the example of FIG. 1, the bar 6 is rearward of the blades 5.

The clamping device(s) can be movably mounted so that they can move into and out of engagement with the bale. Alternatively, in some examples the clamping device(s) may be fixed in place and the bale may be moved towards and away from the clamping device(s) to bring them into and out of engagement with the bale. In the example of FIG. 1, the bar 6 is on the jaw 2. Specifically, the bar 6 is connected between the arms 10 of the jaw 2. In this configuration between the arms 10, the bar may constitute or act as a cross member of the jaw 2. Being movable, the jaw 2 can move the bar 6 into and out of engagement with the bale when the jaw 2 moves. In other examples, the clamping device(s) may be connected elsewhere on the apparatus, for example on a different upper jaw.

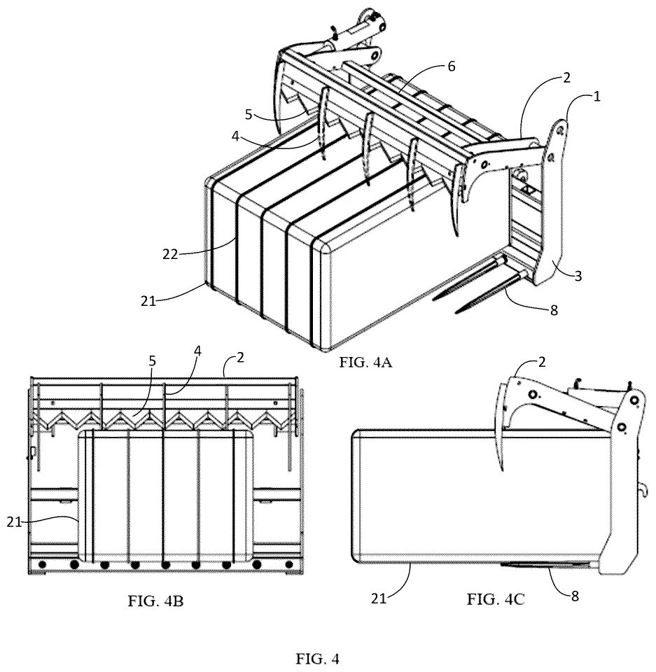

As will be detailed further with reference to FIGS. 4-6, the clamping device(s) may act to retain the binding material on at least a portion of the bale when the bale is cut. The clamping device(s) can also stabilise a bale within the jaws by providing a firm engagement between the bale handling apparatus and the bale at an additional location (other than the location at which the piercing tines 4 pierce the bale and the location at which the blades 5 contact the bale, if they do).

The apparatus 1 can be configured to clamp square bales rearwardly of the blades 5. This may improve the handling of square bales and/or allow cut strings of square bales to be retained on a portion of the square bale while another portion is dropped form the apparatus. The apparatus can clamp onto the top face of a square bale in the jaws. Clamping onto a square bale rearwardly of the cut location can also entail clamping onto binding strings of the square bale.

The bale handling apparatus 1 can also include one or more holders for retaining the binding material on the apparatus 1. The holders can act separately from the clamping device(s) and may retain the binding material even when there is no bale in the jaws. The holders can be selectively actuated to retain or release the binding material. The holders may be hydraulically actuated, for example by the same hydraulic system that actuates the moving jaw(s). In some examples, the hydraulic system driving the jaws and holders can be configured such that the holders are actuated to engage the binding material when the jaws are closed and actuated to release the biding material when the jaws are fully opened. The holders may be configured to be able to hold and retain wrap or netting of round bales and/or string of square bales. In the example of FIG. 1, the holders are in the form of hooks 7. In other examples, other suitable holders may be used.

The holders can be located on one of the jaws of the bale handling apparatus. In the example of FIG. 1, the holders 6 are on the jaw 2. Specifically, the holders are on the bar 6. In other examples, the holders could be located on a different cross member on the jaw 2, on the jaw 3, or on a different jaw of the bale handling apparatus.

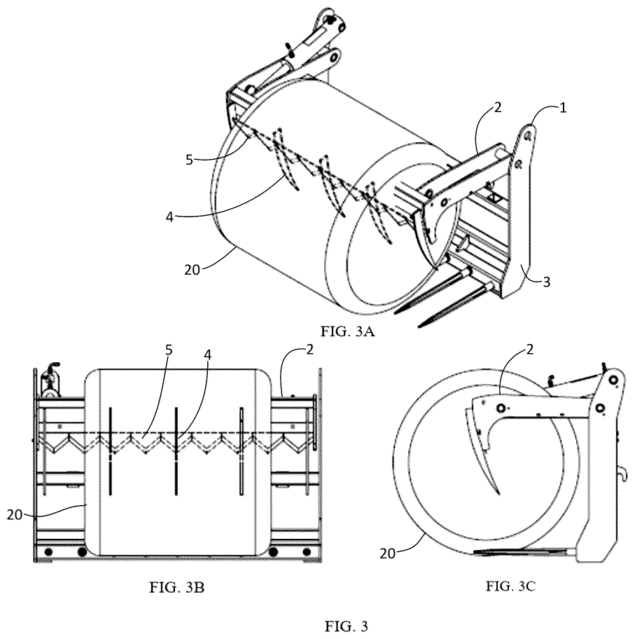

FIGS. 2 and 3 show the bale handling apparatus 1 with a round bale 20 in the jaws 2, 3. FIGS. 2A and 3A are perspective views, FIGS. 2B and 3B are front views and FIGS. 2C and 3C are side views.

Also shown in FIG. 2 are the hydraulic cylinder 15 that drives movement of the upper jaw 2 and a hook 16 (typically there would be two or more hooks) for attaching the bale handling apparatus to a loader arm.

In the configuration shown in FIG. 2, the tines 4 pierce and are partly inserted into the bale 20. This retains the bale in the jaws 2, 3. The bale 20 is supported on the tines 8 of the lower jaw 3. The blades 5 are not inserted into the bale 20 and have not cut the binding material (typically plastic wrap or netting) of the bale 20. This configuration may be used to transport the bale 20. The user may partly close the jaws 2, 3 onto the bale 20 to put the apparatus 1 into this configuration.

In the configuration of FIG. 3, the jaws 2, 3 have been closed further. The blades 5 have cut through the binding material 20 of the bale. The teeth 5 have also cut into the bale 20 to at least partly split the bale 20.

The jaws 2, 3 could be closed further to split the bale 20.

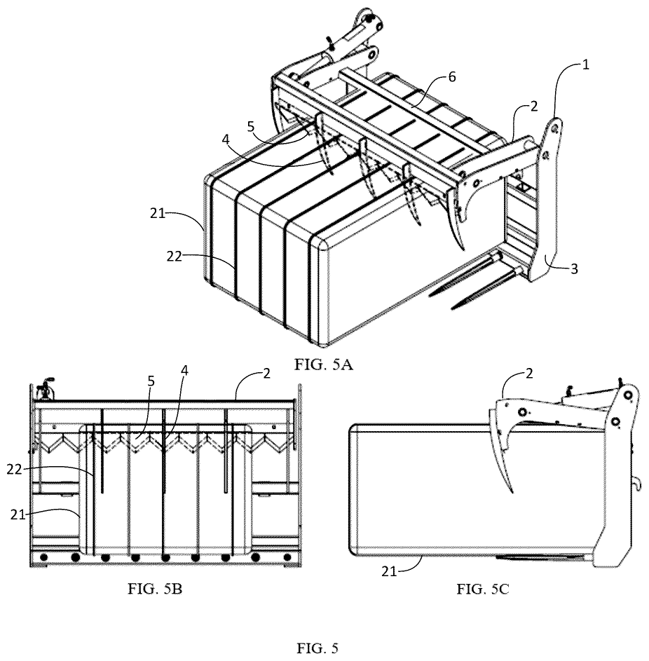

FIGS. 4 and 5 show the bale handling apparatus 1 with a square bale 21 in the jaws 2, 3. FIGS. 4A and 5A are perspective views, FIGS. 4B and 5B are front views and FIGS. 4C and 5C are side views.

The configuration of FIG. 4 is similar to that of FIG. 2 in that the tines 4 pierce and are partly inserted into the bale 21 to retain it in the jaws 2, 3. The bale 21 is supported on the tines 8 of the lower jaw 3. The blades 5 do not cut into the binding material, which is strings 22 on the square bale 21. This configuration may be used for transporting the bale 21.

The bar 6 can clamp onto the bale 21 in this configuration. The bar 6 can be positioned to come into contact with the bale before the blades 5 cut into the bale. This may help to stabilise the bale 21. It may also ensure that the strings 22 are retained on the bale at the rearward portion when the strings are cut and the bale 21 divided. In the example of FIG. 5, the apparatus 1 is configured to clamp onto the upper face of the square bale 21. This means that the bale can be clamped downwards against the bale support (e.g. lower tines 8 of the lower jaw 3).

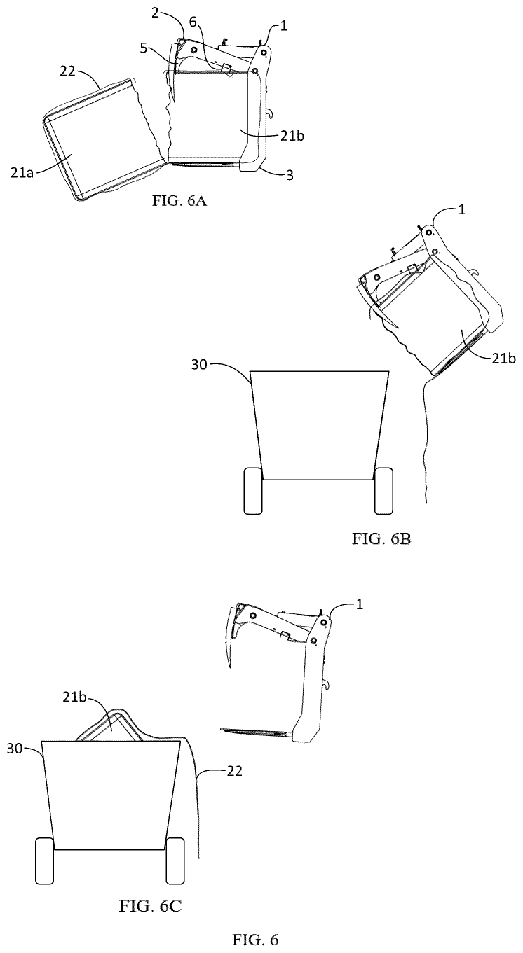

In the configuration of FIG. 5 the jaws 2, 3 have been closed further. The blades 5 have cut the strings 22. The blades 5 have also cut into the bale 21 somewhat, which may help the bale 21 to split. It may not be necessary to cut into the square bale to break it into portions and in other examples the blades may not cut into the square bale. The bar 6 is clamped firmly on the bale 21 and clamps the cut strings 22 onto the rearward portion of the bale 21. As will be illustrated in more detail with reference to FIG. 6, the bale 21 may break when the strings 22 have been cut, allowing the forward portion of the bale to fall from the bale handling apparatus 1 while the rearward portion of the bale is retained in the bale handling apparatus 1.

FIG. 6 illustrates steps of a method of using a bale handling apparatus with a square bale. The bale handling apparatus may be the bale handling apparatus 1 described with reference to FIGS. 1-5. In other examples, the method could be performed using a different but suitably configured bale handling apparatus.

The method will be described in terms of a bale handling apparatus that is configured as an attachment to a loader arm of an agricultural vehicle. The method could alternatively be performed with other bale handler setups, for example when the bale handling apparatus is integrated into a dedicated bale handling machine.

The method includes initially receiving and holding a bale 21 in the bale handling apparatus 1. This may involve a user picking up the bale 21 from the ground or a stack of bales in jaws of the apparatus and partly closing the jaws to hold the bale. The jaws may be closed to a point where they begin to clamp onto the bale. For example, the jaw 2 of the apparatus 1 shown in FIGS. 1-5 may be lowered until the bar 6 engages with the top of the bale 21.

The user may move the bale while it is held by the apparatus. Typically, the user would move the bale to a location where they would like to deposit the baled material. When the user intends to deposit the baled material into a bale holder, for example a bale wagon 30 or a freestanding bale feeder, they can carry the bale 21 over to a point above the bale holder. Typically this would be done by driving the vehicle over to the bale holder and holding the apparatus 1 at a point above the bale holder.

As shown in FIG. 6A, the strings 22 of the bale 21 can then be cut by the bale handling apparatus 1. This may involve the user further lowering the jaw 2 of the bale handling apparatus 1 onto the bale 21 until the blades 5 cut through the string 22. The bar 6 is clamped onto the bale 21 to the rear of where the strings 22 are cut. This retains the strings 22 on the bale 21.

As shown in FIG. 6A, the bale 21 can also be separated into more than one portion using the bale handling apparatus 1. Once the strings 22 are cut, the user can shake the apparatus 1 to cause a portion 21a of the bale 21 to break off while another portion 21b remains in the apparatus 1. It may not be necessary to shake the apparatus in some cases as gravity may be sufficient to cause the portion 21a to break off under its own weight.

The user can drop the portion 21a of the bale in a desired location. In some examples, this could involve dropping the portion 21a into a bale holder, for example an agricultural vehicle such as a wagon for transporting and/or feeding out the baled material. In other examples, this could be a freestanding bale feeder. In FIG. 6B, the portion 21a of the bale (not visible through the sides of the wagon 30) has been dropped into the wagon 30.

The portion 21b of the bale 21 remains in the apparatus 1. The strings 22 of the bale are retained on the portion 21b. If the strings were not retained on the rearward portion 21b of the bale 21, the strings 22 could be pulled out of the apparatus 1 by the portion 21a of the bale as it falls from the apparatus. Instead, the strings are retained on the portion 21b of the bale and prevented from falling with the broken-off portion 21a of the bale (e.g. into the wagon 30). The end of the cut string 22 that was on the portion 21a of the bale can hang loose from the bale handling apparatus 1 as shown in FIG. 6B.

The user can then operate the bale handling apparatus 1 to locate the loose ends of the cut string outside of the bale holder. For example, the user can move the vehicle to pull the loose ends of the strings 22 free from the bale holder. As shown in FIG. 6B, the loose ends of the strings 22 hang free from the wagon 30. Typically, a user of a vehicle would reverse the vehicle after dropping the portion 21a of the bale into the bale holder until the strings are pulled free from the portion 21a and the bale holder.

The user can then drop the portion 21b of the bale into the bale holder with the loose ends of the cut strings 22 outside of the bale holder. Typically, this would be done by a user moving the vehicle forwards to locate the portion 21b over the bale holder while holding the ends of the strings 22 at a height below the top of the bale holder sides. The cut ends of the strings will then be outside of the bale holder and the user can release the portion 21b of the bale to fall into the bale holder while the loose ends of the strings remain draped over the side of the bale holder. In FIG. 6C, the portion 21b of the bale has been dropped into the wagon and the loose ends of the string 22 hang over the side of the wagon 30.

The bale portions 21a, 21b are now loaded into the bale holder. The user can now retrieve the strings 22. The strings 22 can be disposed of properly rather than left in the bale holder or out in the field. Typically, the user would get out of a vehicle that the apparatus 1 is attached to and retrieve the strings manually. The strings can be retrieved without the user having to reach or climb into the bale holder. This may be easier and safer for the user than climbing or reaching into a bale holder.

In a variation on the method described above, the cut strings may be retained in the bale handling apparatus when the second portion 21b of the bale is dropped. This may be done using holders, for example the holders such as hooks 7 detailed above, in the bale handling apparatus. The cut strings may then be deposited from the bale handling apparatus 1 in a desired location separate from the bale holder. This may avoid the need for a user to get out of a vehicle to which the bale handling apparatus 1 is attached when retrieving the cut strings.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

What is claimed is:

1. A bale handling apparatus comprising:
a plurality of jaws configured to receive a bale;
one or more tines configured to pierce the bale when the bale is received in the jaws; and
one or more blades configured to cut binding material of the bale when the bale is received in the jaws;
wherein the bale handling apparatus is configured to clamp the bale at a position rearward of a position at which the one or more blades are configured to cut the binding material.

2. The bale handling apparatus of claim 1 configured to clamp the bale with the plurality of jaws.

3. The bale handling apparatus of claim 1 wherein the bale handling apparatus comprises one or more clamping members located rearwardly of the one or more blades, wherein the bale handling apparatus is configured such that clamping the bale comprises the one or more clamping members clamping onto the bale.

4. The bale handling apparatus of claim 3 wherein the one or more clamping members comprises one or more bars and/or plates.

5. The bale handling apparatus of claim 3 wherein the one or more clamping members are configured to clamp onto the upper face of a square bale.

6. The bale handling apparatus of claim 5 wherein the binding material is string and the bale handling apparatus is configured to clamp and retain the string on at least a portion of the bale.

7. The bale handling apparatus of claim 1 configured to retain a portion of the bale when the binding material is cut and another portion of the bale drops from the bale handling apparatus.

8. The bale handling apparatus of claim 3 wherein the one or more clamping members are on one of the plurality of jaws.

9. The bale handling apparatus of claim 1 wherein the one or more blades are on a first jaw of the plurality of jaws.

10. The bale handling apparatus of claim 9 wherein the first jaw is selectively movable.

11. The bale handling apparatus of claim 3 wherein the one or more blades are on a first jaw of the plurality of jaws and the clamping member is on the first jaw.

12. The bale handling apparatus of claim 10 wherein the plurality of jaws includes a second jaw with a bale support configured to support the base of the bale when the bale is received in the jaws, wherein the bale support comprises a plurality of tines.

13. The bale handling apparatus of claim 1 further comprising one or more hooks for selectively retaining the binding material on the bale handling apparatus and releasing the binding material from the bale handling apparatus.

14. The bale handling apparatus of claim 13 wherein the hooks are on an upper jaw of the plurality of jaws.

15. The bale handling apparatus of claim 4 further comprising one or more hooks for selectively retaining the binding material on the bale handling apparatus and releasing the binding material from the bale handling apparatus wherein the hooks are on the one or more bars and/or plates.

16. The bale handling apparatus of claim 1 further configured such that the blades can slice a round bale in the jaws.

17. A method of operating a bale handling apparatus, the method comprising:
holding a square bale in the bale handling apparatus;
cutting binding strings of the bale with the bale handling apparatus;
dropping a first portion of the bale from the bale handling apparatus while retaining a second portion of the bale in the bale handling apparatus and retaining the cut strings on the second portion of the bale.

18. The method of claim 17 further comprising:
locating loose ends the cut strings outside of a bale holder using the bale handling apparatus; and
dropping the second portion of the bale into the bale handling apparatus while the loose ends remain outside of the bale holder.

19. The method of claim 18 further comprising retaining the cut strings in the bale handling apparatus when dropping the second portion of the bale.

20. The method of claim 17 further comprising, before cutting the binding strings, clamping onto the bale and binding strings at a position rearward of the position at which the binding strings are to be cut.
